(19) United States
(12) Patent Application Publication
(10) Pub. No.: US 2025/0317538 A1
(43) Pub. Date: Oct. 9, 2025

(54) INFORMATION PROCESSING SYSTEM, NON-TRANSITORY COMPUTER-READABLE STORAGE MEDIUM HAVING INFORMATION PROCESSING PROGRAM STORED THEREIN, AND INFORMATION PROCESSING METHOD

(71) Applicant: NINTENDO CO., LTD., Kyoto (JP)

(72) Inventors: Kei YAMASHITA, Kyoto (JP); Tomoaki YOSHINOBU, Kyoto (JP); Kazuma KITAMURA, Kyoto (JP)

(21) Appl. No.: 19/097,260

(22) Filed: Apr. 1, 2025

(30) Foreign Application Priority Data
Apr. 3, 2024 (JP) 2024-060367

(51) Int. Cl. H04N 9/31; A63F 1/00

(52) U.S. Cl. CPC H04N 9/31; A63F 1/00

(57) ABSTRACT

An acquisition process of acquiring correspondence information indicating a correspondence relationship between a coordinate system of a projection device and a coordinate system of an imaging device is performed based on: a taken image obtained by taking an image of a field that has a design and onto which a pattern image in which a plurality of types of polygons are arranged therein is projected; and the pattern image.

### CROSS REFERENCE TO RELATED APPLICATION

This application claims priority to Japanese Patent Application No. 2024-60367 filed on Apr. 3, 2024, the entire contents of which are incorporated herein by reference.

### FIELD

The present disclosure relates to information processing for projecting images using a projector.

### BACKGROUND AND SUMMARY

Hitherto, an image of a pattern image such as a chessboard pattern projected by a projector is taken by a camera, and calibration is performed on a parameter of the projector and/or a parameter of the camera, based on the taken image.

One configuration example of the exemplary embodiments is an information processing system including: one or more processors; a projection device; an imaging device; and a field having a design on a surface thereof, wherein the one or more processors are configured to perform a projection process of causing the projection device to project a pattern image in which a plurality of types of polygons are arranged, onto the surface of the field, an imaging process of causing the imaging device to take an image of the pattern image projected onto the surface of the field, and an acquisition process of acquiring first correspondence information indicating a correspondence relationship between a coordinate system of the projection device and a coordinate system of the imaging device, based on the pattern image and the taken image of the pattern image.

According to the above configuration example, by projecting the pattern image in which a plurality of types of polygons are arranged, onto the field having the design on the surface thereof, even if the design on the field acts as noise, it is possible to more accurately detect the projected pattern image. Therefore, it is possible to obtain a first correspondence relationship, between the coordinate system of the projection device and the coordinate system of the imaging device, on which the influence of noise is suppressed.

In another configuration example, the one or more processors may be configured to: generate a brightness image, based on a difference between a maximum value and a minimum value of brightness for each pixel over a plurality of frames in the taken image; and acquire the first correspondence information by feature amount matching between the brightness image and the pattern image in the acquisition process.

According to the above configuration example, the pattern image projected onto the field can be recognized as a brightness image based on the difference between the maximum value and the minimum value of brightness. Due to this, even if the design on the field and the pattern image projected onto the field overlap, the pattern image projected onto the field can be recognized with reduced influence of the design on the field, so that it is possible to perform feature amount matching having high accuracy.

In another configuration example, the pattern image may be an image in which a plurality of random polygons are arranged.

According to the above configuration example, the regularity of the pattern image is greatly reduced, so that it is possible to further effectively suppress the influence of noise.

In another configuration example, the one or more processors may be configured to: in the projection process, cause the projection device to sequentially project a plurality of the pattern images different from each other in a shape and/or a position of each polygon arranged, onto the surface of the field; in the imaging process, cause the imaging device to take images of the plurality of the pattern images sequentially projected onto the surface of the field; and in the acquisition process, acquire the first correspondence information, based on the plurality of the pattern images and the taken images of the plurality of the pattern images.

According to the above configuration example, since the first correspondence information is acquired using the plurality of the pattern images, it is possible to suppress a decrease in the accuracy of the first correspondence information.

In another configuration example, the field may have a first design on the surface thereof, and the one or more processors may be configured to: cause the imaging device to take an image of the first design on the field; acquire second correspondence information indicating a correspondence relationship between the coordinate system of the imaging device and a coordinate system of the field, by detecting the first design whose image has been taken; and cause the projection device to project a predetermined image in accordance with a position of the field, based on the first correspondence information and the second correspondence information.

According to the above configuration example, the second correspondence information indicating the correspondence relationship between the coordinate system of the imaging device and the coordinate system of the field can be acquired using the first design.

In another configuration example, a game may be played on the field using a combination of a plurality of types of card products, and the first design may be a design indicating the combination.

According to the above configuration example, the second correspondence information indicating the correspondence relationship between the coordinate system of the imaging device and the coordinate system of the field can be acquired using the first design, on the field, indicating the combination of the card products.

In another configuration example, the game may be played using the card products placed on the field, the field may have a second design on the surface thereof, and the second design may be a design indicating a position, on the field, at which the card product is to be placed.

According to the above configuration example, in the case where the field showing the player the position at which the card product is to be placed, using the second design, is used, it is possible to acquire the first correspondence relationship, between the coordinate system of the projection device and the coordinate system of the imaging device, on which the influence of noise is suppressed.

In another configuration example, the first correspondence information may be a projection transformation matrix indicating the correspondence relationship between the coordinate system of the projection device and the coordinate system of the imaging device.

According to the exemplary embodiments, it is possible to provide an information processing system, etc., that can perform calibration that is robust against noise such as a design on a field, when projecting a pattern image onto the field and performing calibration.

### BRIEF DESCRIPTION OF THE DRAWINGS

FIG. 1 shows a non-limiting example of a projection system and a state where the projection system is installed;

FIG. 2 illustrates a non-limiting example of a field;

FIG. 3 illustrates a non-limiting example of markers drawn on the field;

FIG. 4 illustrates a non-limiting example of a state where an image is projected onto the field by the projection system;

FIG. 5 illustrates a process of correcting a distortion of a taken image by associating a field coordinate system with a camera coordinate system;

FIG. 6 illustrates a non-limiting example of pattern images to be projected onto the field;

FIG. 7 illustrates a non-limiting example of a method for generating a pattern image;

FIG. 8 illustrates a non-limiting example of the method for generating a pattern image;

FIG. 9 illustrates a process of associating a projector coordinate system with the camera coordinate system;

FIG. 10 illustrates the process of associating the projector coordinate system with the camera coordinate system; and

FIG. 11 is a non-limiting example of a flowchart of a projection process of an exemplary embodiment.

### DETAILED DESCRIPTION OF NON-LIMITING EXAMPLE EMBODIMENTS

Hereinafter, one exemplary embodiment will be described.

### [Hardware Configuration of Information Processing System]

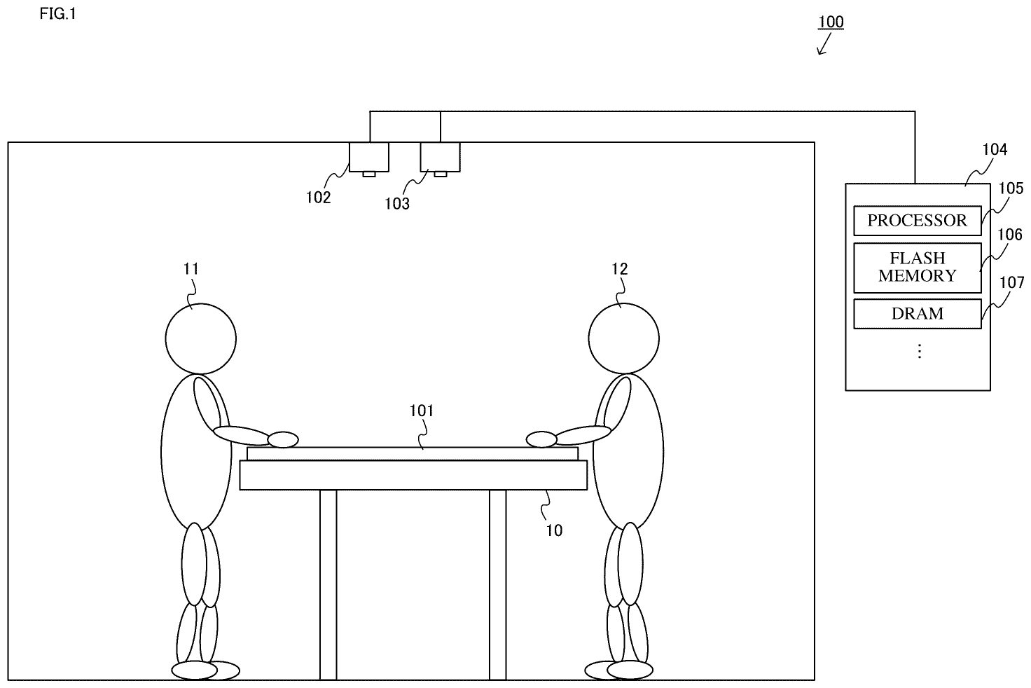

Hereinafter, an information processing system (sometimes referred to as “projection system”) according to one example of the exemplary embodiment will be described. FIG. 1 shows an example of a projection system 100 of the exemplary embodiment and a state where the projection system 100 is installed. In FIG. 1, the projection system 100 includes a field 101, a projection device (sometimes referred to as a “projector”) 102, an imaging device (sometimes referred to as a “camera”) 103, and an information processing apparatus 104.

The information processing apparatus 104 includes a processor 105, a flash memory 106, and a DRAM (dynamic random access memory) 107. The information processing apparatus 104 is connected to the projector 102 and the camera 103 and controls the projector 102 and the camera 103. The information processing apparatus 104 is, for example, a personal computer.

The processor 105 is composed of one or more processors and executes information processing. The processor 105 executes information processing by executing an information processing program stored in a storage section (internal storage medium such as the flash memory 106, an external storage medium attached to the information processing apparatus 104, etc.) The flash memory 106 is a memory that is mainly used to store various data (which may be programs) that are stored in the information processing apparatus 104. The DRAM 107 is a memory that is used to temporarily store various data that are used in information processing. The processor 105 executes information processing by reading and writing data from and in the flash memory 106, the DRAM 107, etc., as appropriate.

The field 101 has a rectangular plate shape or sheet shape as an example, and various designs are drawn on the surface thereof. As will be described later, a player 11 and a player 12 play a card game by placing card products (sometimes simply referred to as “cards”) on the surface of the field 101. In FIG. 1, the field 101 is placed on a desk 10 such that the surface thereof faces upward, and the player 11 and the player 12 are positioned so as to face each other across the field 101 and play the card game.

The projector 102 is placed at a position facing the surface of the field 101 and projects various images onto the surface of the field 101 in accordance with control by the information processing apparatus 104. In FIG. 1, the projector 102 is placed on the ceiling of a room so as to look down on the field 101.

The camera 103 is placed at a position facing the surface of the field 101 and takes an image of the surface of the field 101 in accordance with control by the information processing apparatus 104. In FIG. 1, the camera 103 is placed on the ceiling of the room so as to look down on the field 101.

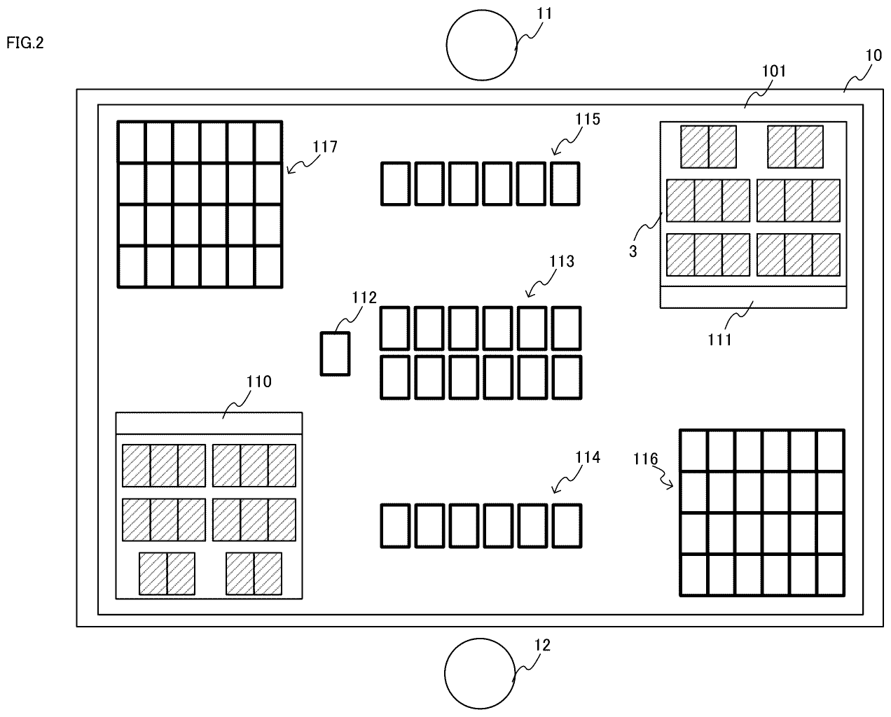

FIG. 2 illustrates an example of the field 101. In the exemplary embodiment, as an example, the two players 11 and 12 play a Hanafuda game in which the players 11 and 12 compete for points using 48 quadrangular Hanafuda cards (one type of card products) on the field 101. The 48 Hanafuda cards have unique designs different from each other, on front surfaces thereof, and back surfaces thereof are all black. In another exemplary embodiment, the game to be played is not limited to the Hanafuda game, and other card games, mahjong games, etc., may be played. In this case, a design corresponding to the game to be played is drawn on the field 101.

As shown in FIG. 2, designs 110 to 117 are drawn on the surface of the field 101. The design 114 is a design of multiple rectangles indicating the positions at which hand cards of the player 12 are to be placed. The design 115 is a design of multiple rectangles indicating the positions at which hand cards of the player 11 are to be placed. The design 113 is a design of multiple rectangles indicating the positions at which table cards are to be placed.

The design 116 is a design of multiple rectangles indicating the positions at which, if a combination of hand cards (Hanafuda cards) of the player 12 placed on the design 114 and table cards (Hanafuda cards) placed on the design 113 constitutes a “yaku (scoring combination)” that is a predetermined combination and the player 12 acquires points corresponding to the scoring combination, the Hanafuda cards constituting the scoring combination are to be placed. The design 117 is a design of multiple rectangles indicating the positions at which, if hand cards (Hanafuda cards) of the player 11 placed on the design 115 and table cards (Hanafuda cards) placed on the design 113 constitutes a “scoring combination” that is a predetermined combination and the player 11 acquires points corresponding to the scoring combination, the Hanafuda cards constituting the scoring combination are to be placed. The design 112 is a design of a single rectangle indicating the position at which Hanafuda cards (deck) other than the Hanafuda cards placed on the above respective designs are to be stacked and placed. On the designs 113 to 117, Hanafuda cards are placed with the front surfaces thereof on the upper side, and on the design 112, Hanafuda cards are placed with the back surfaces thereof on the upper side.

The design 110 is a design showing the player 12 combinations of Hanafuda cards constituting scoring combinations. The design 111 is the same design as the design 110 and is a design showing the player 11 combinations of Hanafuda cards constituting scoring combinations. As shown in FIG. 2, the design 110 and 111 are drawn in opposite orientations.

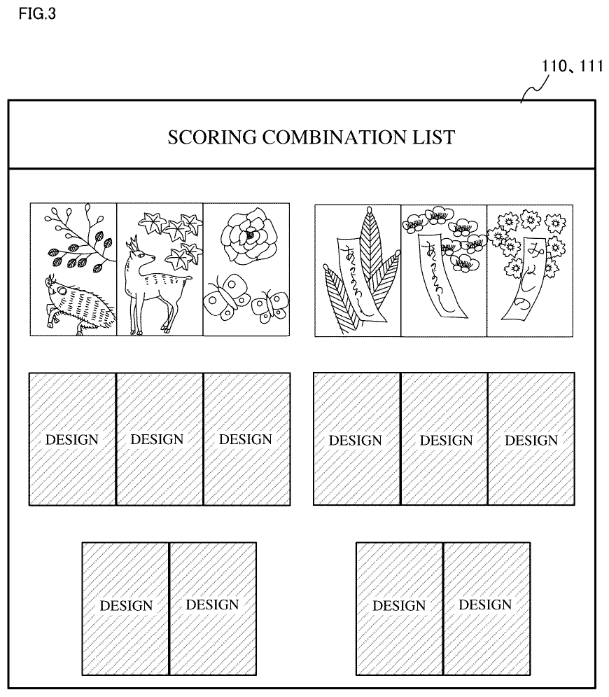

FIG. 3 is an enlarged view of the design 110 and 111 shown in FIG. 2. As shown in FIG. 3, on the designs 110 and 111, a plurality of combinations of Hanafuda cards constituting scoring combinations are drawn, and this helps players who do not remember scoring combinations. In FIG. 3, for the sake of illustration, two types of designs for a scoring combination composed of a combination of three Hanafuda cards are shown, while designs for other scoring combinations are omitted and represented by diagonal lines and the word “design” is shown thereon.

In the Hanafuda game of the exemplary embodiment, each player makes a scoring combination with a combination of table cards and Hanafuda cards placed as their own hand cards, acquires points corresponding to the made scoring combination, and competes for points. The detailed description of the rules is omitted. The projection system 100 supports the Hanafuda game by recognizing Hanafuda cards constituting a scoring combination from among the table cards and the Hanafuda cards placed as hand cards, and showing the recognized scoring combination to the players using a projected image (sometimes referred to as a “support image”) from the projector 102.

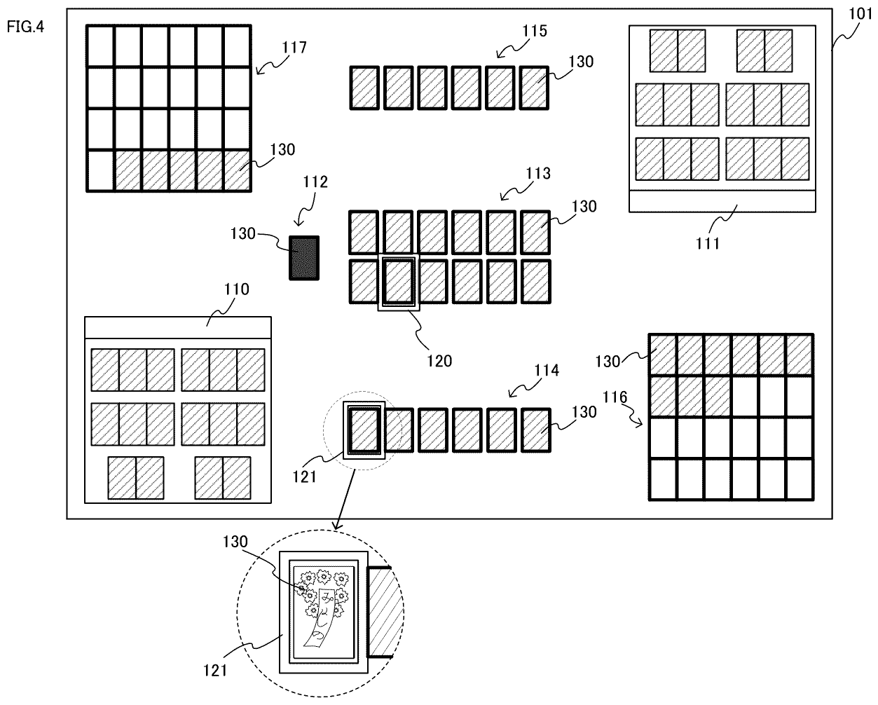

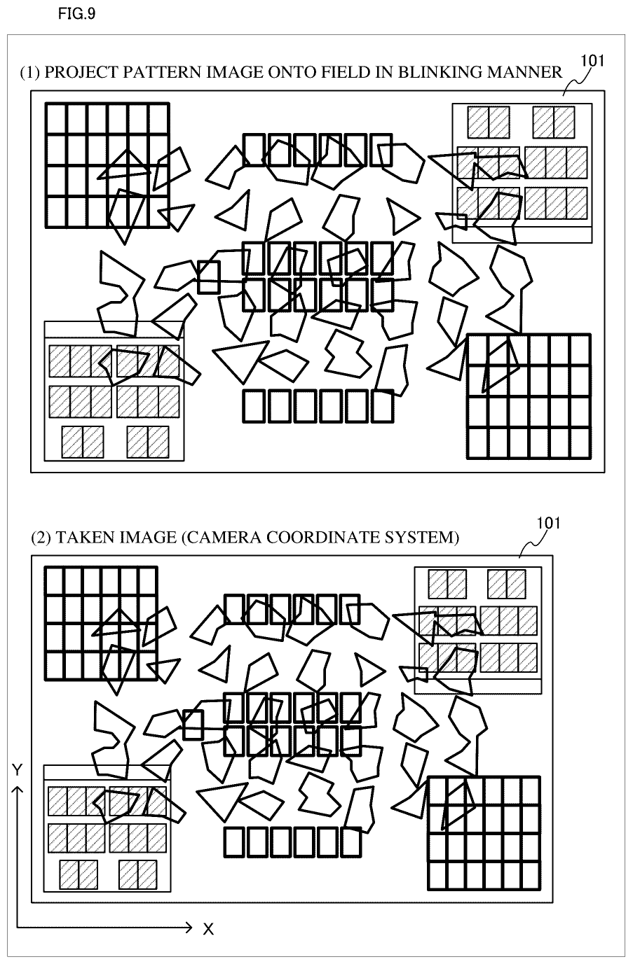

FIG. 4 illustrates an example of a state where a predetermined image showing Hanafuda cards constituting a scoring combination is projected onto the field 101 by the projection system 100 of the exemplary embodiment. In FIG. 4, Hanafuda cards are indicated by reference character 130. Also, in FIG. 4, for the sake of illustration, the designs on the front surfaces of the Hanafuda cards are omitted and represented by diagonal lines, and the designs of the scoring combination portions in the designs 110 and 111 are omitted and represented by diagonal lines. In FIG. 2 and FIG. 9 as well, the designs of the scoring combination portions in the designs 110 and 111 are omitted and represented by diagonal lines.

In FIG. 4, a combination of one of Hanafuda cards that are the table cards and one of Hanafuda cards that are the hand cards constitutes a scoring combination. As shown in FIG. 4, a support image 121 having a quadrangular frame shape for surrounding a Hanafuda card is projected onto the Hanafuda card constituting the scoring combination, thereby showing the player that it is possible to make the scoring combination. In another exemplary embodiment, in order to indicate which Hanafuda card is a Hanafuda card that can constitute a scoring combination (in order to indicate the Hanafuda card onto which the support image 121 has been projected), a support image having a straight line shape connecting projected support images 121 having a frame shape may be projected.

Here, in the projection system 100, if a correspondence relationship between a coordinate system of the field 101 onto which the support image 121 is projected (sometimes referred to as “world coordinate system”), a coordinate system of the projector 102 that projects the support image 121 (sometimes referred to as “projector coordinate system”), and a coordinate system of the camera 103 (sometimes referred to as “camera coordinate system”) is not appropriately adjusted, the support image 121 is not projected in an appropriate position, orientation, shape, or size. Therefore, in the exemplary embodiment, the correspondence relationship between the world coordinate system, the projector coordinate system, and the camera coordinate system is adjusted by processes described later.

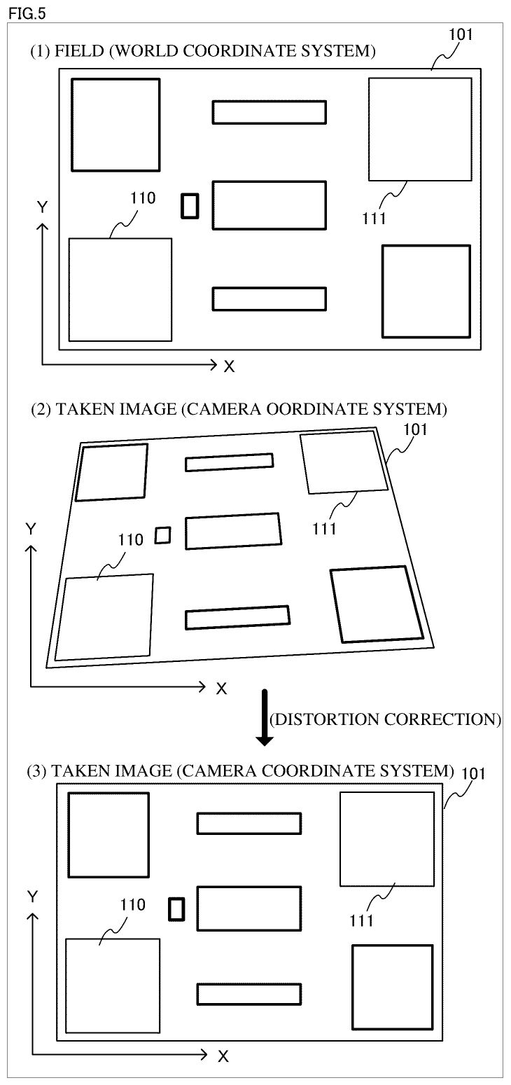

FIG. 5 illustrates a process of correcting a distortion of a taken image by associating the field coordinate system with the camera coordinate system. For the sake of illustration, FIG. 5 is a simplified diagram. FIG. 5(1) shows the world coordinate system in which the field 101 is placed (see FIG. 1, etc.). FIG. 5(2) shows a taken image (camera coordinate system) that is an image of the field 101 taken by the camera 103. As shown in FIG. 5, the orientation, etc., of the camera 103 relative to the field 101 are misaligned, and thus the shape of the field 101 in the taken image is distorted.

Here, the designs 110 and 111 drawn on the field 101 are known in terms of content, shape, and size thereof and positional relationship therebetween (see FIG. 2 and FIG. 3). Therefore, based on the above known data (sometimes referred to as “marker data”) stored in advance in the flash memory 106 or the like, the processor 105 recognizes the designs 110 and 111 in the taken image in FIG. 5(2), using the designs 110 and 111 as markers. Then, the processor 105 calculates a projection transformation matrix that reflects the shapes and sizes of the designs 110 and 111 and the positional relationship therebetween that are indicated by the marker data, in the taken image of the camera coordinate system shown in FIG. 5(2). That is, the processor 105 calculates a projection transformation matrix that defines a correspondence relationship between the world coordinate system and the camera coordinate system (sometimes referred to as “first projection transformation matrix”). Then, the processor 105 corrects the distortion of the taken image, as shown in FIG. 5(3), by transforming the taken image using the first projection transformation matrix.

Next, a process of associating the projector coordinate system with the camera coordinate system in order to project the support image 121 onto a position on the field 101 recognized based on the taken image (see FIG. 5(3)) (see FIG. 4), without any misalignment, will be described.

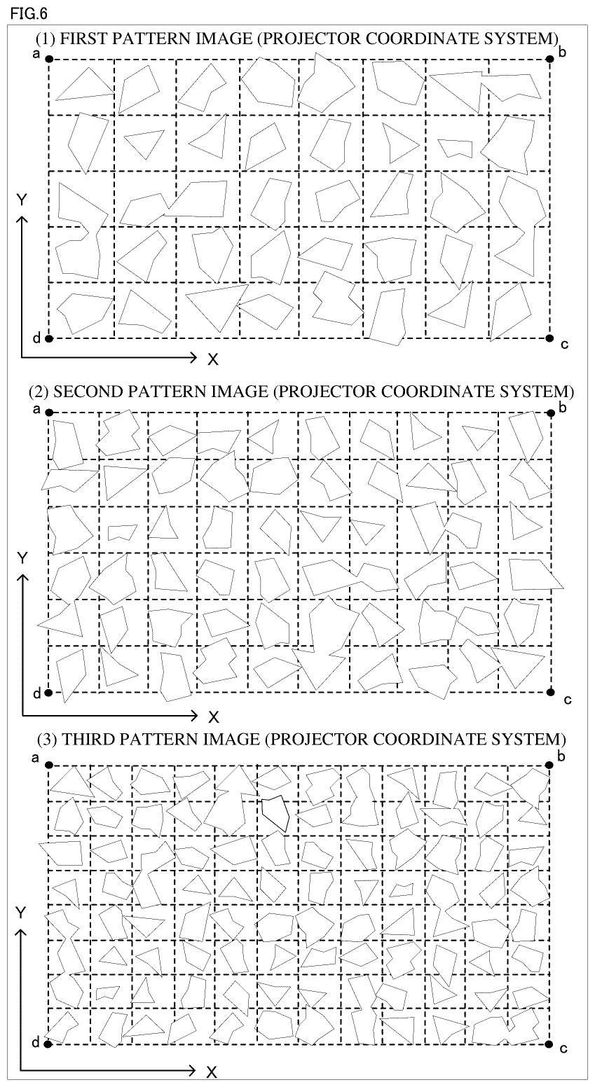

FIG. 6 shows an example of three pattern images that are sequentially projected onto the field 101 by the projector 102 in order to associate the projector coordinate system with the camera coordinate system. As will be described later, these pattern images are projected onto a position overlapping the designs (see FIG. 2) of the field 101 (see FIG. 2 and FIG. 9(1)). As shown in FIG. 6(1), a first pattern image is an image in which four points (point a, point b, point c, and point d) in the projector coordinate system are vertices and polygons different from each other are placed at division frames in a rectangle (sometimes referred to as the “first rectangle”) that is divided into five sections in the vertical direction and eight sections in the horizontal direction. As shown in FIG. 6(2), a second pattern image is an image in which the four points (point a, point b, point c, and point d) in the projector coordinate system are vertices and polygons different from each other are placed at division frames in a rectangle (sometimes referred to as the “second rectangle”) that is divided into six sections in the vertical direction and ten sections in the horizontal direction. As shown in FIG. 6(3), a third pattern image is an image in which the four points (point a, point b, point c, and point d) in the projector coordinate system are vertices and polygons different from each other are placed at division frames in a rectangle (sometimes referred to as the “third rectangle”) that is divided into eight sections in the vertical direction and twelve sections in the horizontal direction. The coordinates of the four vertices (point a, point b, point c, and point d) of the first rectangle, the second rectangle, and the third rectangle are the same coordinates in the projector coordinate system, respectively.

The first rectangle, the second rectangle, the third rectangle, and the division frames of these rectangles which are shown by broken lines in FIG. 6 are illustrated for convenience of description, and do not constitute the pattern image, and the polygons arranged in these rectangles are projected as pattern images. In addition, in FIG. 6, etc., for the sake of illustration, there are a plurality of polygons having the same shape, etc., but the shape of each polygon is different from each other. Moreover, in FIG. 6, polygons are arranged at frames into which a rectangle is divided, but polygons may be arranged at frames into which a square is divided. Moreover, in FIG. 6, if polygons come into contact with each other, the boundary between the polygons is eliminated and the polygons are combined. In another exemplary embodiment, polygons having the same shape and/or the same size may exist in a single pattern image.

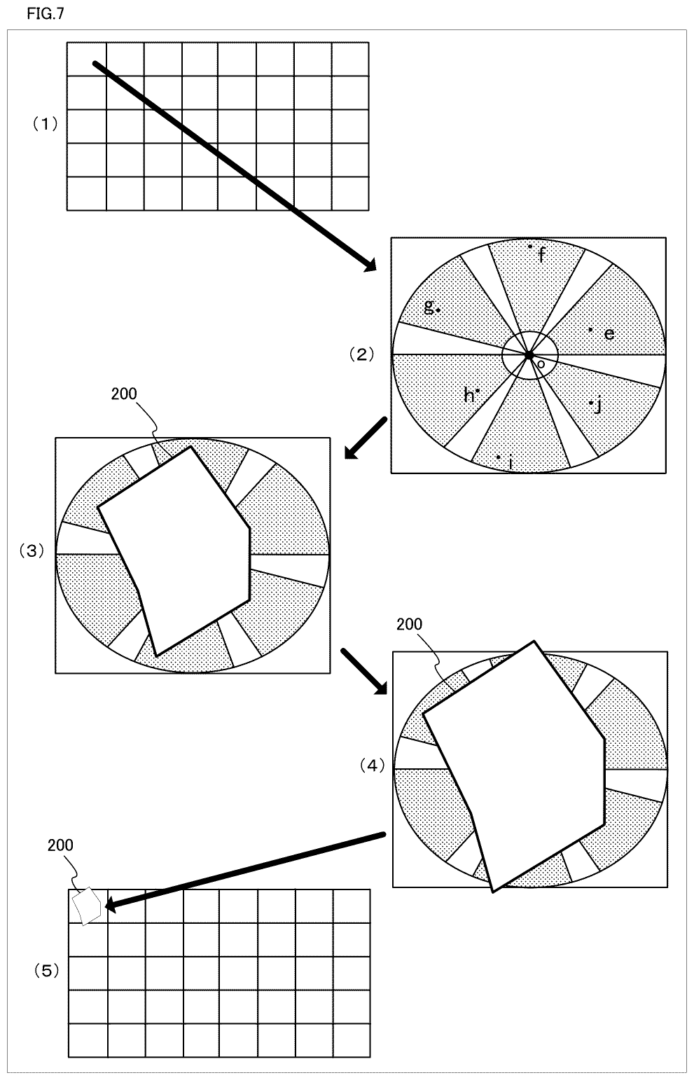

FIG. 7 illustrates a method for generating a pattern image. Specifically, FIG. 7 illustrates a method for generating the first pattern image in which 40 polygons are arranged, but the second pattern image in which 60 polygons are arranged and the third pattern image in which 96 polygons are arranged, are also generated in the same manner. In addition, FIG. 7 shows the case where a random polygon is generated at the upper left division frame of the first rectangle, but at each of the other division frames, a random polygon is also generated similarly.

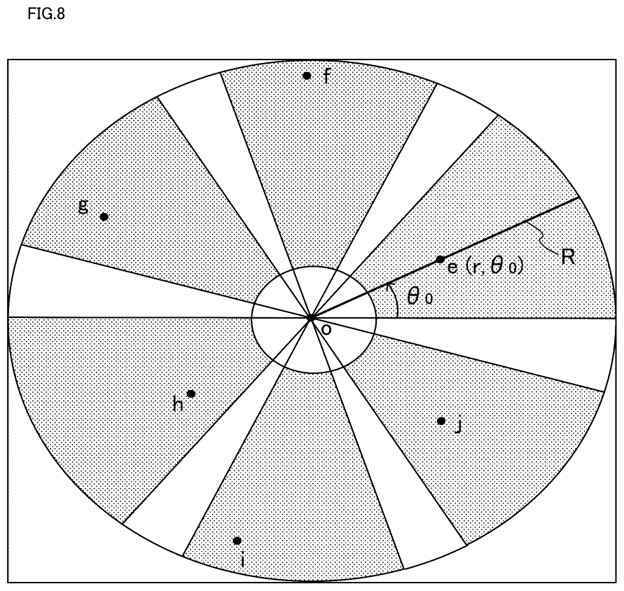

As shown in FIG. 7(2), the processor 105 defines an ellipse that is inscribed in the division frame (see FIG. 7(1)) at which a polygon is to be generated. Next, the processor 105 randomly determines a number N of vertices of the polygon to be generated from among 3 to 8. FIG. 7 shows the case where the number N of vertices is determined to be 6. Next, the processor 105 determines the coordinates of each vertex of the polygon to be generated. FIG. 8 is an enlarged view of FIG. 7(2). A method for determining the coordinates of each vertex of the polygon to be generated will be described with reference to FIG. 8.

The coordinates of each vertex of the polygon to be generated are determined as polar coordinates (r, Ok), where the center o of the ellipse is a pole, a distance from the pole o is r, and a deflection angle is 0 [rad], as shown in FIG. 8. The deflection angle θk (k=0, 1 . . . N−1) of the polar coordinates is determined randomly within a range defined by [Math. 1].

$$( 2 k π ) / ( N ) \leq [ θ ] \_ ( k ) \leq ( 2 ( k + 0.75 ) π ) / N \qquad [ Math . 1 ]$$

Hereinafter, a specific description will be given using FIG. 8.

First, the case of determining the polar coordinates of the first vertex e is considered. In this case, k=0, and a deflection angle θ0 of the polar coordinates of the vertex e are determined randomly from the range where k=0 in [Math. 1]. In FIG. 8, θ0 is determined to be π/7. Next, as shown in FIG. 8, among straight lines defined by the coordinates that can be taken as the polar coordinates (r, θ0), a straight line R connecting the center o (pole o) to the circumference of the ellipse is specified. A value obtained by multiplying the length of the straight line R by a value determined randomly from the range of 0.2 to 1.0 is determined as the distance r from the pole o. In FIG. 8, a value obtained by multiplying the length of the straight line R by a value of 0.5, which is randomly determined, is determined as the distance r from the pole o. That is, a length that is half the length of the straight line R is determined as the distance r from the pole o.

In the case of determining the polar coordinates (r, θ1) of the second vertex f, k=1, and a deflection angle θ1 of the polar coordinates of the vertex f is determined randomly from the range where k=1 in [Math. 1]. In addition, r of the polar coordinates of the vertex f is determined randomly by the method described above. The polar coordinates (r, θ2) of the third vertex g, the polar coordinates (r, θ3) of the fourth vertex h, the polar coordinates (r, θ4) of the fifth vertex i, and the polar coordinates (r, θ5) of the sixth vertex j are also determined in the same manner.

When the coordinates of each vertex of the polygon are determined as described above (see FIG. 8 and FIG. 7(2)), a polygon defined by the determined vertices is specified as shown in FIG. 7(3). Then, as shown in FIG. 7(4), the specified polygon is fixed at the position of the center o of the ellipse and enlarged using an enlargement factor randomly selected from among values of 1.2, 1.4, and 1.6. In FIG. 7(4), the specified polygon is enlarged by 1.2 times in size using an enlargement factor of 1.2. A random polygon is generated for each of all the division frames as described above, and the first pattern image, the second pattern image, and the third pattern image are generated.

FIG. 9(1) illustrates a state where the first pattern image (see FIG. 6(1)) is projected in a blinking manner onto the surface of the field 101 by the projector 102. The projector 102 projects the pattern image in a blinking manner, for example, by repeating a process of projecting the pattern image for 0.5 seconds and then suspending projection for 0.5 seconds five times. FIG. 9(1) shows a time at which the first pattern image is projected.

FIG. 9(2) shows a taken image (video) that is an image of the field 101 (see FIG. 9(1)), onto which the first pattern image is projected, taken by the camera 103. In the taken image (video) shown in FIG. 9(2), the blinking first pattern image is shown. Here, the taken image (video) is an image in which the distortion of the taken image has been corrected using the first projection transformation matrix described with reference to FIG. 5(first projection transformation matrix that defines the correspondence relationship between the world coordinate system and the camera coordinate system).

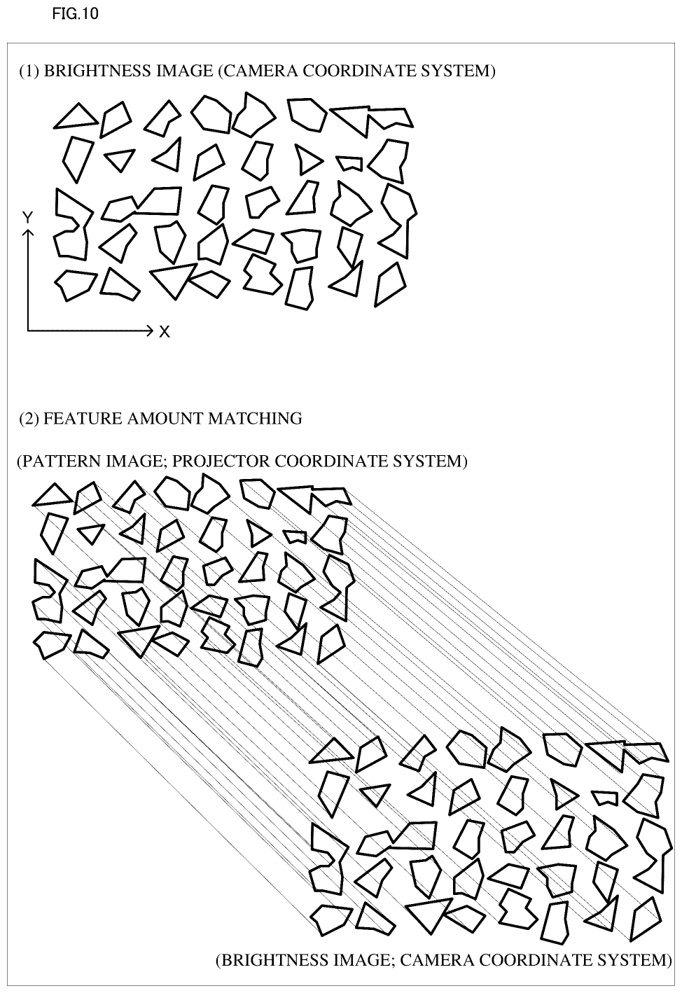

FIG. 10(1) shows a brightness image generated by calculating the difference between the maximum value and the minimum value of brightness for each pixel of the taken image (see FIG. 9(2)) which is a video and then imaging the difference therebetween. As shown in FIG. 10(1), the brightness image is ideally an image having the shape of the first pattern image shown in the taken image. However, as shown in FIG. 9(2), in the taken image, the first pattern image is shown so as to overlap the designs drawn on the field 101, so that these designs may act as noise and the shape of the first pattern image in the brightness image may partially change. Also, if Hanafuda cards and other objects (smartphone, etc.) are placed on the field 101, these objects may act as noise and the shape of the first pattern image in the brightness image may partially change.

FIG. 10(2) shows feature amount matching performed between the first pattern image and the brightness image. As shown in FIG. 10(2), the processor 105 performs feature amount matching between the first pattern image (projector coordinate system) and the brightness image (camera coordinate system), thereby detecting corresponding feature points between the first pattern image and the brightness image. A large number of straight lines in FIG. 10(2) are straight lines connecting the corresponding feature points.

In addition, the processor 105 performs the same process using the second pattern image to detect corresponding feature points between the second pattern image and a brightness image of the second pattern image. Moreover, the processor 105 performs the same process using the third pattern image to detect corresponding feature points between the third pattern image and a brightness image of the third pattern image.

Then, the processor 105 specifies the correspondence relationship between the coordinates of each feature point in the first pattern image and the coordinates of each feature point in the brightness image calculated using the first pattern image (that is, the correspondence relationship between the projector coordinate system and the camera coordinate system). Similarly, the processor 105 specifies the correspondence relationship between the coordinates of each feature point in the second pattern image and the coordinates of each feature point in the brightness image calculated using the second pattern image, and specifies the correspondence relationship between the coordinates of each feature point in the third pattern image and the coordinates of each feature point in the brightness image calculated using the third pattern image. That is, the processor 105 calculates projection transformation matrixes using the first pattern image, the second pattern image, and the third pattern image, respectively. Then, the processor 105 calculates a correspondence relationship obtained by averaging the above three specified correspondence relationships (sometimes referred to as “average correspondence relationship”) and calculates a projection transformation matrix that defines the average correspondence relationship (sometimes referred to as “second projection transformation matrix”). Hereinafter, an example of a method for calculating the second projection transformation matrix will be described specifically.

First, using the projection transformation matrix calculated using the first pattern image, the coordinates of four points (a1, b1, c1, d1) in the camera coordinate system corresponding to the coordinates of the four corners (a, b, c, d; see FIG. 6) of the first pattern image (projector coordinate system) are calculated. In addition, using the projection transformation matrix calculated using the second pattern image, the coordinates of four points (a2, b2, c2, d2) in the camera coordinate system corresponding to the coordinates of the four corners (a, b, c, d) of the second pattern image are calculated. Moreover, using the projection transformation matrix calculated using the third pattern image, the coordinates of four points (a3, b3, c3, d3) in the camera coordinate system corresponding to the coordinates of the four corners (a, b, c, d) of the third pattern image are calculated.

In addition, a reliability score s1 for the projection transformation calculated using the first pattern image, a reliability score s2 for the projection transformation calculated using the second pattern image, and a reliability score s3 for the projection transformation calculated using the third pattern image are calculated. One example of a method for calculating each reliability score will be described. The coordinates obtained when the coordinates of each feature point included in the first pattern image (projector coordinate system; see FIG. 6(1) and FIG. 10(2)) are transformed into the camera coordinate system using the projection transformation matrix calculated using the first pattern image are calculated. Then, the difference (distance) between the calculated respective coordinates in the camera coordinate system and the coordinates of each feature point obtained from the brightness image (camera coordinate system; see FIG. 10(1)) of the first pattern image is calculated for each pair of feature points. Then, the average value of the calculated differences (distances) is defined as “difference value of projection transformation”, and the reliability score s1 is calculated using the calculation formula [reliability score=1/(1+difference value of projection transformation)]. Similarly, the reliability score s2 and the reliability score s3 are calculated.

Then, using the calculated reliability scores, “weighted average values” are respectively calculated for the coordinates of the four points in the camera coordinate system corresponding to the four corners (a, b, c, d) of each pattern image. Specifically, a4=(s1×a1+s2×a2+s3×a3)/(s1+s2+s3) is calculated as the weighted average value of a1, a2, and a3. In addition, b4=(s1×b1+s2×b2+s3×b3)/(s1+s2+s3) is calculated as the weighted average value of b1, b2, and b3. Moreover, c4=(s1×c1+s2×c2+s3×c3)/(s1+s2+s3) is calculated as the weighted average value of c1, c2, and c3. Moreover, d4=(s1×d1+s2×d2+s3×d3)/(s1+s2+s3) is calculated as the weighted average value of d1, d2, and d3. That is, the average correspondence relationship is calculated.

Then, the second projection transformation matrix that transforms the coordinates of the points a, b, c, and d in the projector coordinate system into the coordinates of the points a4, b4, c4, and d4 in the camera coordinate system, is calculated. By calculating the second projection transformation matrix using the weighted average values as described above, it is possible to calculate a second projection transformation matrix having high reliability.

Then, by transforming and correcting the taken image using the calculated second projection transformation matrix, the support image 121 can be projected onto an appropriate position, without any misalignment, as described with reference to FIG. 4. That is, calibration can be performed for the camera coordinate system of the camera 103.

Here, it is conceivable to perform calibration for the camera coordinate system as described above, using a chessboard pattern having a regular shape as the pattern image, rather than using the pattern image (see FIG. 6) in which random polygons are arranged. However, in this method, since the chessboard pattern has a regular shape, if the designs (the designs drawn on the field 101, the designs of the Hanafuda cards and other objects placed on the field 101, etc.) that overlap the chessboard pattern act as noise in the projected image and the shape of the pattern image in the brightness image partially changes, the accuracy of feature amount matching may decrease significantly. In this case, calibration cannot be appropriately performed for the camera coordinate system, and the support image 121 cannot be projected onto an appropriate position without any misalignment (see FIG. 4) in some cases. On the other hand, in the exemplary embodiment, since the pattern image (see FIG. 6) in which random polygons are arranged is used as described above, it is possible to perform accurate calibration that is robust against noise.

In addition, the larger the number of polygons included in the pattern image is, the larger the number of feature points obtained by feature amount matching is (see FIG. 6(3)), and thus the more the accuracy of calibration is improved. Meanwhile, if the resolution of the pattern image projected onto the field 101 by the projector 102 is low and the pattern image is not clear, or if the resolution of the image taken by the camera 103 is low and the taken image is not clear, the larger the number of polygons included in the pattern image is, the lower the accuracy of feature amount matching is, and thus the lower the accuracy of calibration is. Therefore, in the exemplary embodiment, as described above, the second projection transformation matrix is calculated using the first pattern image, the second pattern image, and the third pattern image (see FIG. 6), which have different numbers of polygons included in the pattern image. This makes it possible to suppress a decrease in the accuracy of calibration.

### Details of Information Processing of Exemplary Embodiment

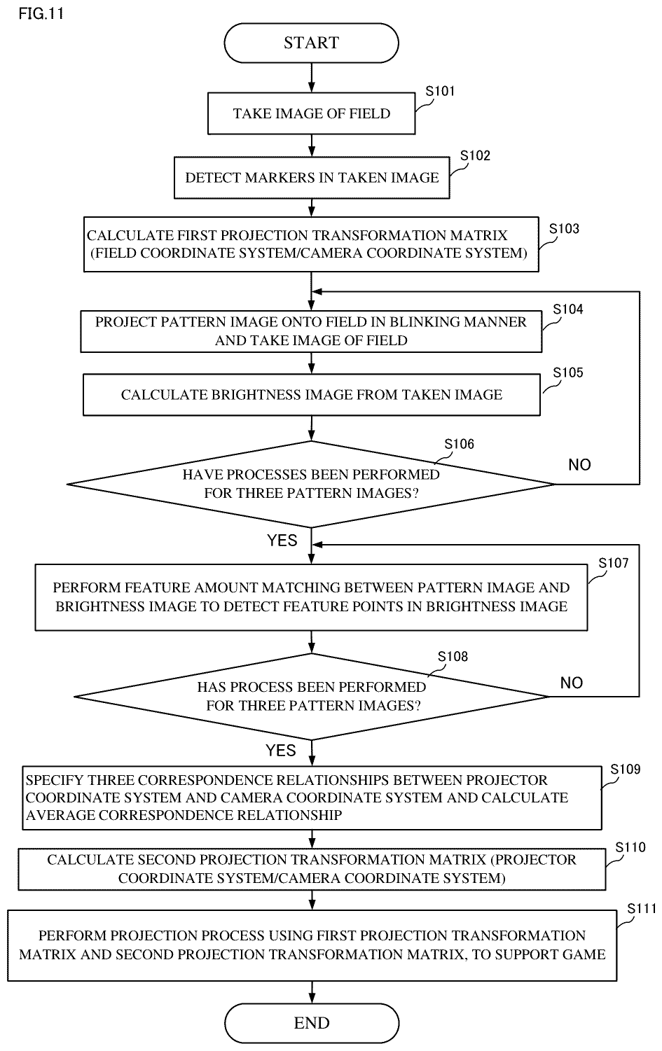

FIG. 11 is an example of a flowchart of the exemplary embodiment. An example of the information processing of the exemplary embodiment will be described in detail with reference to FIG. 11. When the projection system 100 is started up and this information processing is started, a process in FIG. 11 is started.

First, in step S101, the processor 105 controls the projector 102 to take an image of the field 101 as described with reference to FIGS. 5(1) and (2). Then, the process proceeds to step S102.

In step S102, based on the marker data stored in advance in the flash memory 106 or the like, the processor 105 detects markers (designs 110 and 111) in the taken image obtained in step S101, as described with reference to FIG. 5(2). Then, the process proceeds to step S103.

In step S103, based on the marker data and the markers in the taken image, the processor 105 calculates the first projection transformation matrix that defines the correspondence relationship between the world coordinate system and the camera coordinate system, as described with reference to FIGS. 5(2) and (3). Then, the process proceeds to step S104.

In step S104, the processor 105 controls the projector 102 to project the pattern image (see FIG. 6) stored in advance in the flash memory 106 or the like, in a blinking manner onto the field 101, and controls the camera 103 to take an image of the field 101 onto which the pattern image has been projected, as described with reference to FIG. 9. The pattern image may be generated by the processor 105 when performing the process in step S104. Then, the process proceeds to step S105.

In step S105, the processor 105 calculates a brightness image, based on the taken image (video) obtained in step S104, as described with reference to FIG. 10(1). Then, the process proceeds to step S106.

In step S106, the processor 105 determines whether or not the processes in step S104 and S105 have been performed for the three pattern images (first to third pattern images described with reference to FIG. 6). If the result of this determination is YES, the process proceeds to step S107, and if the result of this determination is NO, the process returns to step S104. By the processes in step S104 to S106, brightness images are calculated for the three pattern images.

In step S107, the processor 105 performs feature amount matching between each pattern image and the brightness image calculated from the pattern image, to detect feature points for the brightness image, as described with reference to FIG. 10(2). Then, the process proceeds to step S108.

In step S108, the processor 105 determines whether or not the process in step S107 has been performed for the three pattern images (see the first to third pattern images described with reference to FIG. 6). If the result of this determination is YES, the process proceeds to step S109, and if the result of this determination is NO, the process returns to step S107. By the processes in step S107 and S108, feature points are detected for each of the three brightness images. Then, the process proceeds to step S109.

In step S109, as already described, the processor 105 specifies three correspondence relationships between the projector coordinate system and the camera coordinate system and calculates the average correspondence relationship of the three specified correspondence relationships. Then, the process proceeds to step S110.

In step S110, the processor 105 calculates the second projection transformation matrix that defines the calculated average correspondence relationship between the camera coordinate system and the projector coordinate system, as described in the description of FIG. 10(2). Then, the process proceeds to step S111.

In step S111, the processor 105 performs a projection process using the first projection transformation matrix calculated in step S103 and the second projection transformation matrix calculated in step S109, to project the support image 121 onto the field 101, for example, as described with reference to FIG. 4, thereby supporting the Hanafuda game. Then, if, for example, the Hanafuda game ends and the projection system 100 is stopped, this information processing is terminated.

As described above, according to the exemplary embodiment, since the pattern image (see FIG. 6) in which random polygons are arranged is used, it is possible to prevent a significant decrease in the accuracy of feature amount matching due to the influence of the designs drawn on the field 101, etc., so that it is possible to perform accurate calibration that is robust against noise. In addition, as described above, according to the exemplary embodiment, since the second projection transformation matrix is calculated using the first pattern image, the second pattern image, and the third pattern image (see FIG. 6) which have different numbers of polygons included in the pattern image, it is possible to suppress a decrease in the accuracy of calibration.

### [Modifications]

In the above exemplary embodiment, a case in which a series of processes regarding the information processing are executed in a single information processing apparatus has been described. In another exemplary embodiment, the series of processes may be executed in a system including a plurality of information processing apparatuses. For example, in a system including a terminal-side apparatus and a server-side apparatus communicable with the terminal-side apparatus via a network, some of the series of processes above may be executed by the server-side apparatus. Further, in a system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above system, the system on the server side may be implemented by a plurality of information processing apparatuses, and processes that should be executed on the server side may be shared and executed by a plurality of information processing apparatuses.

While the exemplary embodiment and the modifications have been described, the description thereof is in all aspects illustrative and not restrictive. It is to be understood that various other modifications and variations may be made to the exemplary embodiment and the modifications.

What is claimed is:

1. An information processing system comprising:
one or more processors;
a projection device;
an imaging device; and
a field having a design on a surface thereof, wherein
the one or more processors are configured to perform
a projection process of causing the projection device to project a pattern image in which a plurality of types of polygons are arranged, onto the surface of the field,
an imaging process of causing the imaging device to take an image of the pattern image projected onto the surface of the field, and
an acquisition process of acquiring first correspondence information indicating a correspondence relationship between a coordinate system of the projection device and a coordinate system of the imaging device, based on the pattern image and the taken image of the pattern image.

2. The information processing system according to claim 1, wherein the one or more processors are configured to:
generate a brightness image, based on a difference between a maximum value and a minimum value of brightness for each pixel over a plurality of frames in the taken image; and
acquire the first correspondence information by feature amount matching between the brightness image and the pattern image in the acquisition process.

3. The information processing system according to claim 1, wherein the pattern image is an image in which a plurality of random polygons are arranged.

4. The information processing system according to claim 1, wherein the one or more processors are configured to:
in the projection process, cause the projection device to sequentially project a plurality of the pattern images different from each other in a shape and/or a position of each polygon arranged, onto the surface of the field;
in the imaging process, cause the imaging device to take images of the plurality of the pattern images sequentially projected onto the surface of the field; and
in the acquisition process, acquire the first correspondence information, based on the plurality of the pattern images and the taken images of the plurality of the pattern images.

5. The information processing system according to claim 1, wherein
the field has a first design on the surface thereof, and
the one or more processors are configured to:
cause the imaging device to take an image of the first design on the field;
acquire second correspondence information indicating a correspondence relationship between the coordinate system of the imaging device and a coordinate system of the field, by detecting the first design whose image has been taken; and
cause the projection device to project a predetermined image in accordance with a position of the field, based on the first correspondence information and the second correspondence information.

6. The information processing system according to claim 5, wherein
a game is played on the field using a combination of a plurality of types of card products, and
the first design is a design indicating the combination.

7. The information processing system according to claim 6, wherein
the game is played using the card products placed on the field,
the field has a second design on the surface thereof, and
the second design is a design indicating a position, on the field, at which the card product is to be placed.

8. The information processing system according to claim 1, wherein the first correspondence information is a projection transformation matrix indicating the correspondence relationship between the coordinate system of the projection device and the coordinate system of the imaging device.

9. A non-transitory computer-readable storage medium having stored therein an information processing program causing one or more processors of an information processing apparatus to perform:
a projection process of causing a projection device to project a pattern image in which a plurality of types of polygons are arranged, onto a surface of a field having a design on the surface thereof;
an imaging process of causing an imaging device to take an image of the pattern image projected onto the surface of the field; and
an acquisition process of acquiring first correspondence information indicating a correspondence relationship between a coordinate system of the projection device and a coordinate system of the imaging device, based on the pattern image and the taken image of the pattern image.

10. The storage medium according to claim 9, wherein the information processing program causes the one or more processors to:
generate a brightness image, based on a difference between a maximum value and a minimum value of brightness for each pixel over a plurality of frames in the taken image; and
acquire the first correspondence information by feature amount matching between the brightness image and the pattern image in the acquisition process.

11. The storage medium according to claim 9, wherein the pattern image is an image in which a plurality of random polygons are arranged.

12. The storage medium according to claim 9, wherein the information processing program causes the one or more processors to:
in the projection process, cause the projection device to sequentially project a plurality of the pattern images different from each other in a shape and/or a position of each polygon arranged, onto the surface of the field;
in the imaging process, cause the imaging device to take images of the plurality of the pattern images sequentially projected onto the surface of the field; and
in the acquisition process, acquire the first correspondence information, based on the plurality of the pattern images and the taken images of the plurality of the pattern images.

13. The storage medium according to claim 9, wherein
the field has a first design on the surface thereof, and
the one or more processors are configured to:
cause the imaging device to take an image of the first design on the field;
acquire second correspondence information indicating a correspondence relationship between the coordinate system of the imaging device and a coordinate system of the field, by detecting the first design whose image has been taken; and
cause the projection device to project a predetermined image in accordance with a position of the field, based on the first correspondence information and the second correspondence information.

14. The storage medium according to claim 13, wherein
a game is played on the field using a combination of a plurality of types of card products, and
the first design is a design indicating the combination.

15. The storage medium according to claim 14, wherein
the game is played using the card products placed on the field,
the field has a second design on the surface thereof, and
the second design is a design indicating a position, on the field, at which the card product is to be placed.

16. The storage medium according to claim 9, wherein the first correspondence information is a projection transformation matrix indicating the correspondence relationship between the coordinate system of the projection device and the coordinate system of the imaging device.

17. An information processing method executed by one or more processors of an information processing apparatus, the information processing method causing the one or more processors to perform:
a projection process of causing a projection device to project a pattern image in which a plurality of types of polygons are arranged, onto a surface of a field having a design on the surface thereof;
an imaging process of causing an imaging device to take an image of the pattern image projected onto the surface of the field; and
an acquisition process of acquiring first correspondence information indicating a correspondence relationship between a coordinate system of the projection device and a coordinate system of the imaging device, based on the pattern image and the taken image of the pattern image.
